(19) United States
(12) Patent Application Publication
(10) Pub. No.: US 2014/0283330 A1
(43) Pub. Date: Sep. 25, 2014

(54) Platform for attaching a portable vacuum unit on a container

(71) Applicant: Leo Tardif, Repentigny (CA)

(72) Inventor: Leo Tardif, Repentigny (CA)

(21) Appl. No.: 13/848,714

(22) Filed: Mar. 21, 2013

(51) Int. Cl. A01G 1/12

(52) U.S. Cl. CPC A01G 1/125
USPC 15/347

(57) ABSTRACT

A platform for a portable vacuum unit having a flat upper surface with two openings therethrough, and a flat lower surface including a seal member attached around its entire perimeter and adapted to engage an entire upper rim of a holding container. One of the openings is an intake opening having a gasket member attached around its entire perimeter, a second of the openings being a filter assembly opening having a gasket member attached around its entire perimeter. An intake connector member, and a filter assembly adapted to be removably connected to the gasket of the second opening and adapted such that when a portable vacuum unit is connected to the filter assembly, debris can be sucked by the portable vacuum unit into the holding container.

### FIELD OF THE INVENTION

The present invention relates generally to vacuuming devices but more particularly to a device which carries a portable vacuum cleaner unit over various types of containers.

### BACKGROUND OF THE INVENTION

There exist various types of motorized gardening tools, including blowers, vacuums, and shredders. These devices need to be held or carried by the user. Also, in the case of vacuum cleaners and shredders, there is a need for some sort of container such as a bag, a barrel, a trailer or a wheelbarrow that can contain the collected matter after shredding.

Applicant has filed patent U.S. Pat. No. 8,091,815 for a similar device for use with a vacuum and shredder apparatus wherein the collected matter is sucked and shredded and which can be fitted onto a variety of devices. Since all of the collected matter is shredded, the device can be used only to collect shredable material.

### SUMMARY OF THE INVENTION

A practical device that can attach a portable vacuum unit to a container wherein the collected matter is stored without shredding. This is important when collecting matter that is not shredable or that is intended for recycling where shredding would not be advisable.

In order to do so, the invention consists of a platform for a portable vacuum unit having a flat upper surface with two openings therethrough, and a flat lower surface including a seal member attached around its entire perimeter and adapted to engage an entire upper rim of a holding container. One of the openings is an intake opening having a gasket member attached around its entire perimeter, a second of the openings being for the portable vacuum unit having a gasket member attached around its entire perimeter. An intake connector member adapted to be removably connected to the gasket of the intake opening. An intake elbow member adapted to be removably connected to the intake connector member, and the portable vacuum unit adapted to be removably connected to the gasket of the opening, and adapted such that when the portable vacuum unit is connected, debris can be sucked by the portable vacuum unit into the holding container.

The perimeter of the platform is formed from a shape that is adapted to fit snugly upon the upper rims of most holding containers.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Top and side views, respectively, of the invention installed on top of a container with a portable vacuum unit.

FIG. 2 Exploded view of the invention.

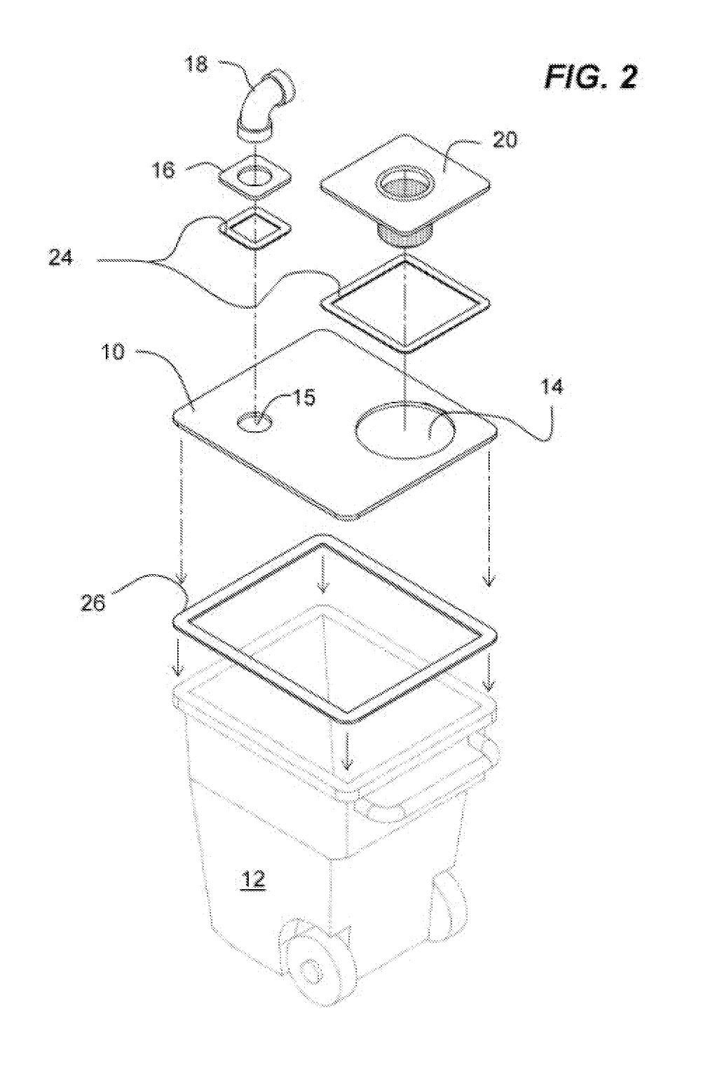

FIG. 3 Isometric view of the invention.

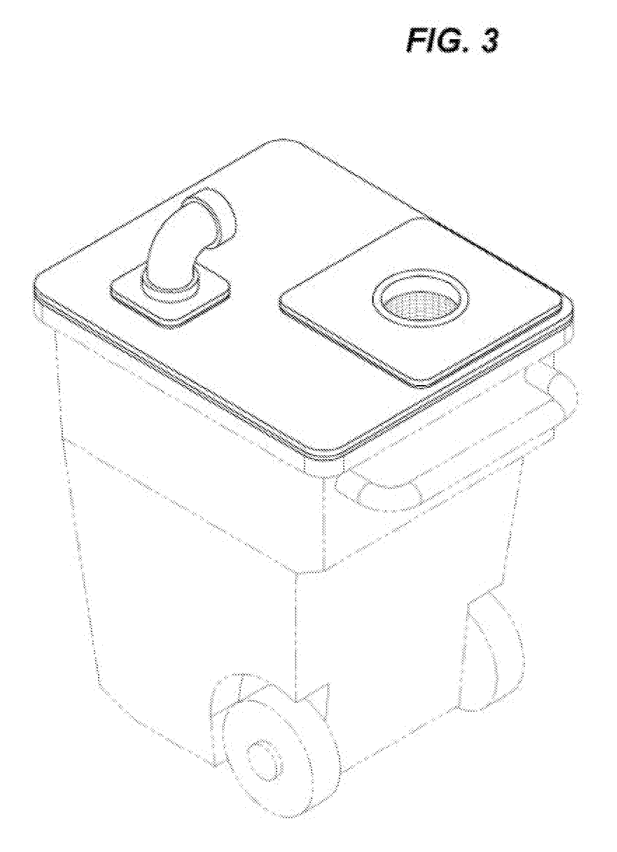

FIGS. 4a-b Top and side views, respectively, of the invention using a workshop vacuum cleaner.

### DETAILED DESCRIPTION OF THE PREFERRED EMBODIMENT

A platform (10) for a portable vacuum unit (11) is configured and sized so that it can be used over a container (12).

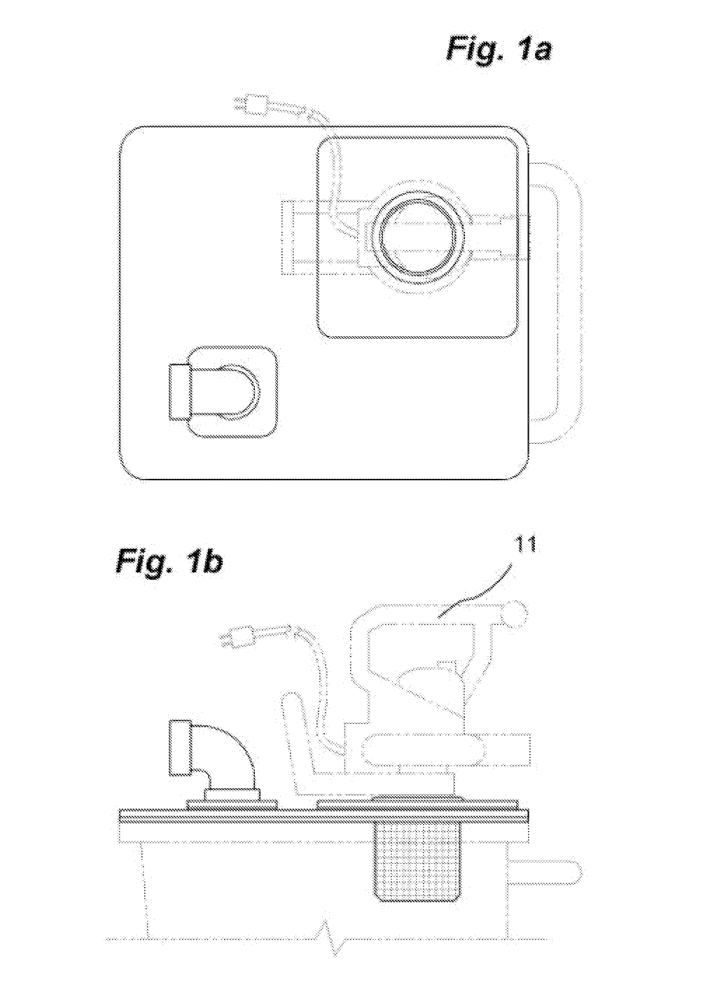

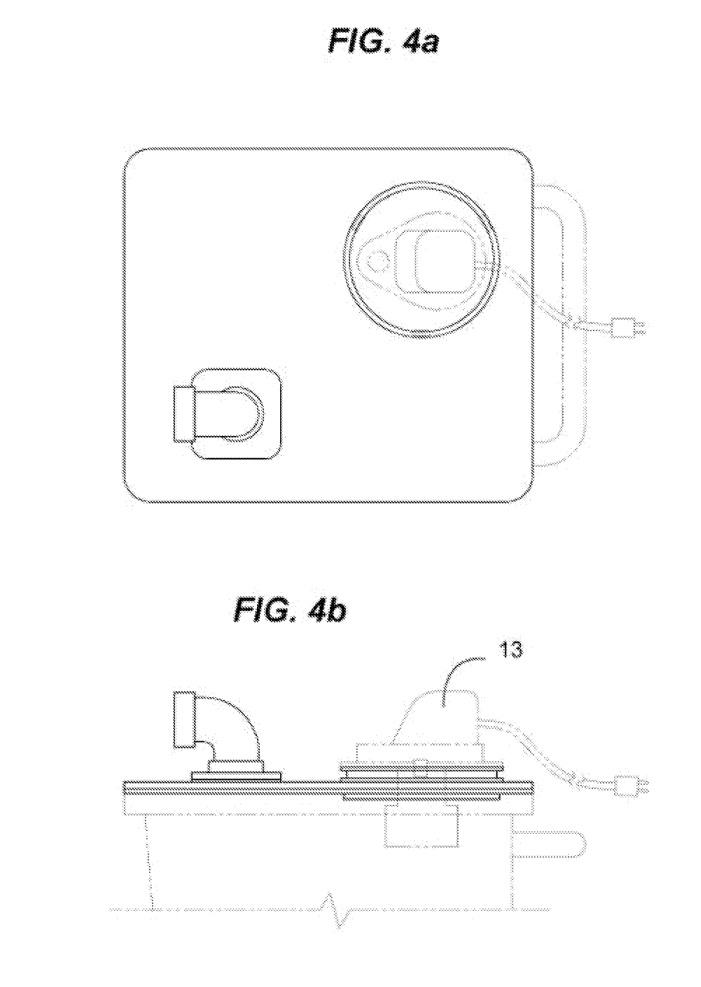

The portable vacuum unit (11) can be installed in different configurations as seen in FIG. 1 but also, a workshop vacuum cleaner (13) can be used as well as seen in FIGS. 4a-b.

The common elements are the platform (10) which has two openings wherein a first opening (15) is for an intake connector (16) which connects to an intake elbow (18) and; a second opening (14) is for the filter assembly (20) on which the portable vacuum unit (11) connects. There are also gaskets (24) to create a seal between the connectors (16), the filter assembly (20), the platform (10), and the container (12). There is also a perimeter seal (26) to create a seal between the platform (10) and the container (12). When using a commercially available workshop vacuum, a filter assembly is already part of the workshop vacuum.

A filter assembly (20) is placed before the debris vacuum (11) to retain the collected matter inside the container (12).

When using a workshop vacuum (13), the platform (10) uses the filtering system of the work shop vacuum (13) instead of the filter assembly (20) of the debris vacuum (11).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A platform for a portable vacuum unit comprising a flat upper surface having at least two openings therethrough, and a flat lower surface including a seal member attached around its entire perimeter and adapted to engage an entire upper rim of a holding container; one of said openings being an intake opening having a gasket member attached around its entire perimeter; a second of said openings having a gasket member attached around its entire perimeter; an intake connector member adapted to be removably connected to said gasket of said intake opening; an intake elbow member adapted to be removably connected to said intake connector member; and a filter assembly adapted to be removably connected to said gasket of said filter assembly opening, and adapted such that when a vacuum apparatus is connected to said filter assembly, debris can be sucked by said vacuum apparatus and into said holding container.

2. The unit of claim 1, wherein said perimeter of said platform is formed from a shape that is adapted to fit snugly upon the upper rims of most holding containers.

3. A vacuum apparatus comprising a vacuum member; and a platform; said platform including a flat upper surface having at least two openings therethrough, and a flat lower surface including a seal member attached around its entire perimeter and adapted to engage an entire upper rim of a holding container; one of said openings being an intake opening having a gasket member attached around its entire perimeter; a second of said openings having a gasket member attached to its entire perimeter; an intake connector member adapted to be removably connected to said gasket of said intake opening; an intake elbow member adapted to be removably connected to said intake connector member; and a filter assembly adapted to be removably connected to said gasket of said second opening; wherein said portable vacuum unit is connected to said filter assembly, such that debris can be sucked by said portable vacuum unit through said intake opening by said portable vacuum unit and into said holding container.

4. The portable vacuum apparatus of claim 3, wherein said perimeter of said platform is formed from a shape that is adapted to fit snugly upon the upper rims of most holding containers.
